(19) United States
(12) Patent Application Publication
(10) Pub. No.: US 2016/0188288 A1
(43) Pub. Date: Jun. 30, 2016

(54) METHOD AND MOBILE DEVICE FOR PLAYING MUSIC BASED ON MOVEMENT

(71) Applicant: FIH (HONG KONG) LIMITED, Kowloon (HK)

(72) Inventor: TA-LUN SHE, Shindian (TW)

(21) Appl. No.: 14/726,120

(22) Filed: May 29, 2015

(30) Foreign Application Priority Data
Dec. 30, 2014 (TW) 103146312

(51) Int. Cl. G06F 3/16

(52) U.S. Cl. CPC G06F 3/165

(57) ABSTRACT

A music playing method executable on a mobile device includes acquiring parameters measured by a wearable device, a velocity of a user is determined according to the acquired parameters, then according to a predetermined corresponding relation between categories of music and ranges of movement speeds, a piece of music for the movement is selected and played.

### CROSS-REFERENCE TO RELATED APPLICATIONS

This application claims priority to Taiwanese Patent Application No. 103146312 filed on Dec. 30, 2014, the contents of which are incorporated by reference herein.

### FIELD

The subject matter herein generally relates to smart mobile device technology, and particularly to a method and mobile device for playing music based on a movement of a user.

### BACKGROUND

Listening to music using a mobile device (e.g., a smart phone or a tablet computer) while exercising can improve efficiency of movement.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a mobile device including a music playing system.

FIG. 2 is a block diagram of one embodiment of function modules of the music playing system in the mobile device in FIG. 1.

FIG. 3 illustrates a flowchart of one embodiment of a method for playing music based on a movement of a user.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

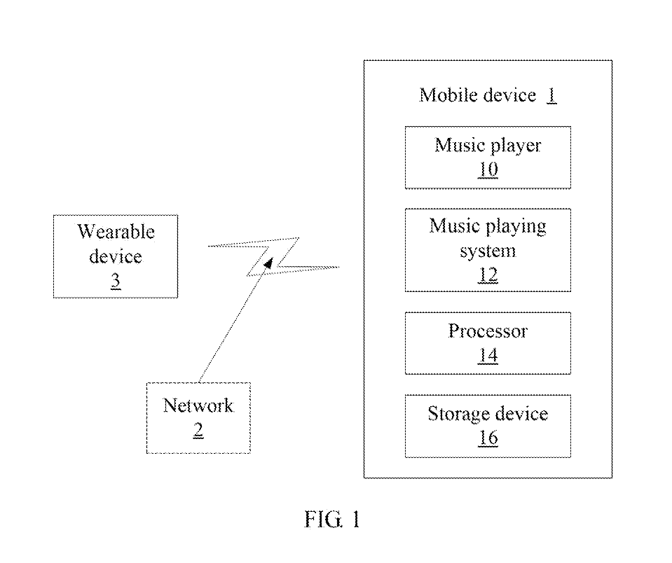

FIG. 1 illustrates a block diagram of one embodiment of a mobile device. In at least one embodiment, as shown in FIG. 1, the mobile device 1 includes a music playing system 12. The mobile device 1 further includes, but is not limited to, a music player 10, at least one processor 14, and a storage device 16. The mobile device 1 can be a tablet computer, a smart phone, a MP4, or any other music playing device. FIG. 1 illustrates only one example of the mobile device 1 that can include more or fewer components than illustrated, or have a different configuration of the various components in other embodiments.

In at least one embodiment, the at least one processor 14 can be a central processing unit (CPU), a microprocessor, or other data processor chip that performs function of the music playing system 12 in the mobile device 1.

In at least one embodiment, the storage device 16 can include various types of non-transitory computer-readable storage medium. For example, the storage device 16 can be an internal storage system, such as a flash memory, a random access memory (RAM) for temporary storage of information, and/or a read-only memory (ROM) for permanent storage of information. The storage device 16 can also be an external storage system, such as a hard disk, a storage card, or a data storage medium.

In at least one embodiment, the mobile device 1 can communicate with a wearable device 3 using a network 2. The wearable device 3 can be, or include, a physical sensor that senses the environment, such as a motion sensor, an acceleration sensor, or a heart rate monitor. The network 2 can provide a wireless communication between the mobile device 1 and the wearable device 2. The network 2 can be a Wi-Fi network, or any suitable short distance wireless communication network. In some embodiments, the network 2 can be a wired network.

In at least one embodiment, the wearable device 3 can measure movement local parameters of a user, and transmit the parameters to the mobile device 1. In some embodiments, the parameters comprise heart rate, breathing rate, slope table, velocity, acceleration, or a combination thereof.

The music playing system 12 can execute playing music based on the movement parameters.

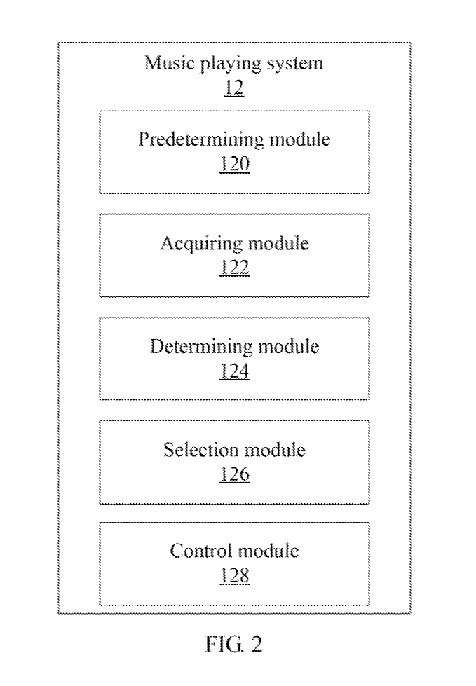

FIG. 2 is a block diagram of one embodiment of function modules of the music playing system. In at least one embodiment, a music playing system 12 can include a predetermination module 120, an acquiring module 122, a determining module 124, a selection module 126, and a control module 128. The function modules 120, 122, 124, 126, and 128 can include computerized codes in the form of one or more programs, which are stored in the storage device 16 of the mobile device 1. The at least one processor 14 executes the computerized codes to provide functions of the function modules.

The predetermination module 120 can predetermine a corresponding relation between categories of music and ranges of movement speeds, each category identifying at least one piece of music. In at least one embodiment, the storage device 16 of the mobile device 1 can store a plurality of music. The music can be categorized into different music categories according to rhythm, tempo, or genres. The movements can include jogging, running, walking slowly, walking fast, climbing, riding a bicycle, and so on.

The acquiring module 122 can acquire parameters measured by a wearable device 3 wore by a user. In some embodiments, the parameters comprise heart rate, breathing rate, slope table, velocity, acceleration, or a combination thereof.

The determining module 124 can determine a velocity of the user according to the acquired parameters.

In at least one embodiment, when a velocity of user is between 50-70 steps per minute, the determining module 124 can determine that the user is walking slowly When a velocity of user is between 120-150 steps per minute, the determining module 124 can determine that the user is walking fast. When a velocity of user is between 150-190 steps per minute, the determining module 124 can determine the user is running.

The selection module 126 can select a piece of music from the storage device 16 for the movement according to the predetermined corresponding relation between categories of music and ranges of movement speeds.

In at least one embodiment, according to the predetermined corresponding relation, for example, when the user is riding a bicycle, then the selection module 126 can select a piece of music which has a slow beat but heavy rhythm. When the user is walking slowly, the selection module 126 can select a piece of soft relaxing music. When the user is running, the selection module 126 can select a piece of lively rhythm music for inspiration.

The control module 128 can control a music player 10 to play the selected music. In some embodiments, the music player 10 is controlled to play the selected music after a current music being played ends. In one embodiment, when the selected music is played, the selected music is added to a playlist.

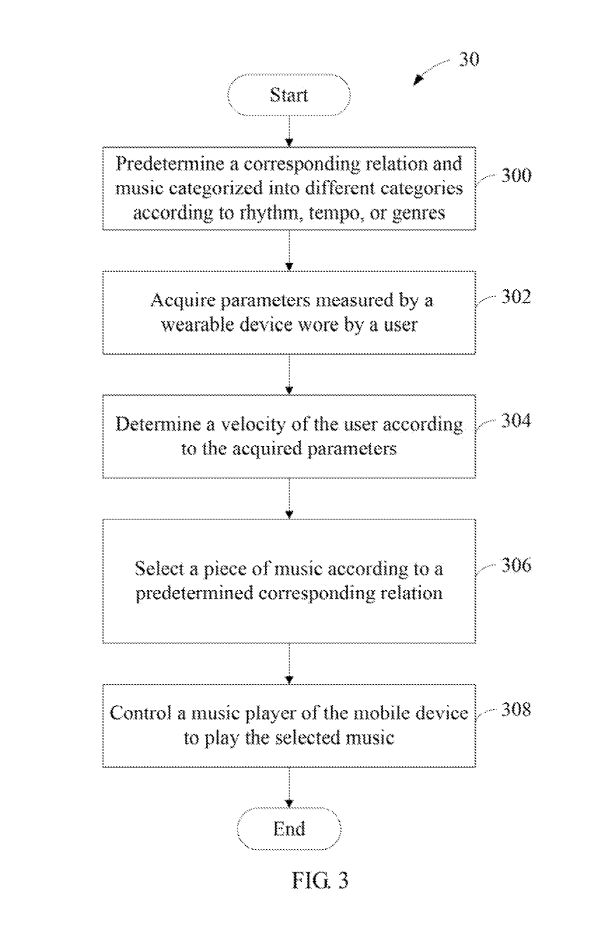

Referring to FIG. 3, a flowchart is presented in accordance with an example embodiment. An example method 30 is provided by way of example, as there are a variety of ways to carry out the method. The example method 30 described below can be carried out using the configurations illustrated in FIG. 1 and FIG. 2, for example, and various elements of these figures are referenced in explaining example method 30. Each block shown in FIG. 3 represents one or more processes, methods, or subroutines, carried out in the example method 30. Additionally, the illustrated order of blocks is by example only and the order of the blocks can be changed. The example method 30 can begin at block 300. Depending on the embodiment, additional blocks can be added, others removed, and the ordering of the blocks can be changed.

At block 300, a predetermination module predetermines a corresponding relation and music categorized into different music categories according to rhythm, tempo, or genres.

At block 302, an acquiring module acquires parameters measured by a wearable device 3 wore by a user.

At block 304, a determining module determines a velocity of the user according to the acquired parameters.

At block 306, a selection module selects music from a storage device 16 for the movement according to the predetermined corresponding relation between categories of music and ranges of movement speeds.

At block 308, a control module controls a music player 10 to play the selected music.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for playing music based on a movement executable on a mobile device having a music player and at least one processor, the method comprising:
acquiring parameters measured by a wearable device wore by a user;
determining, using the at least one processor, a velocity of the user according to the acquired parameters;
selecting a piece of music according to a predetermined corresponding relation between categories of music and ranges of movement speeds, each category identifying at least one piece of music; and
controlling the music player to play the selected music.

2. The method according to claim 1, wherein the music stored in a storage device of the mobile device is categorized according to rhythm, tempo, or genres.

3. The method according to claim 1, wherein the movement parameters comprise heart rate, breathing rate, slope table, velocity, acceleration, or a combination thereof.

4. The method according to claim 1, wherein the movements comprise jogging, running, walking slowly, walking fast, climbing, riding a bicycle.

5. The method according to claim 1, wherein the music player is controlled to play the chosen music after a current music being played ends.

6. A mobile device, comprising:
a music player;
at least one processor; and
a storage device that stores one or more programs which, when executed by the at least one processor, cause the at least one processor to:
acquire parameters measured by a wearable device wore by a user;
determine, using the at least one processor, a velocity of the user according to the acquired parameters;
select a piece of music according to a predetermined corresponding relation between categories of music and ranged of movement speeds, each category identifying at least one piece of music; and
control the music player to play the selected music.

7. The mobile device according to claim 6, wherein the music stored in the storage device of the mobile device is categorized according to rhythm, tempo, or genres.

8. The mobile device according to claim 6, wherein the movement parameters comprise heart rate, breathing rate, slope table, velocity, acceleration, or a combination thereof.

9. The mobile device according to claim 6, wherein the movements comprise jogging, running, walking slowly, walking fast, climbing, riding a bicycle.

10. The mobile device according to claim 6, wherein the music player is controlled to play the chosen music after a current music being played ends.

11. A non-transitory storage medium having stored thereon instructions that, when executed by at least one processor of a mobile device, causes the at least one processor to perform a method for playing music based on a movement, the mobile device comprising a music player, wherein the method comprises:
acquiring parameters measured by a wearable device wore by a user;
determining, using the at least one processor, a velocity of the user according to the acquired parameters;
selecting a piece of music according to a predetermined corresponding relation between categories of music and ranges of movement speeds, each category identifying at least one piece of music; and
controlling the music player to play the selected music.

12. The non-transitory storage medium according to claim 11, wherein the music stored in the storage device of the mobile device is categorized according to rhythm, tempo, or genres.

13. The non-transitory storage medium according to claim 11, wherein the movement parameters comprise heart rate, breathing rate, slope table, velocity, acceleration, or a combination thereof.

14. The non-transitory storage medium according to claim 11, wherein the movements comprise jogging, running, walking slowly, walking fast, climbing, riding a bicycle.

15. The non-transitory storage medium according to claim 11, wherein the music player is controlled to play the chosen music after a current music being played ends.
